(19) United States
(12) Patent Application Publication
(10) Pub. No.: US 2007/0235503 A1
(43) Pub. Date: Oct. 11, 2007

(54) Solder alloy and soldering method

(75) Inventors: Goro Izuta, Tokyo (JP); Koji Hiraoka, Tokyo (JP); Katsuaki Suganuma, Minoh-shi (JP)

Correspondence Address: BUCHANAN, INGERSOLL & ROONEY PC, POST OFFICE BOX 1404, ALEXANDRIA, VA, 22313-1404, US

(73) Assignee: Mitsubishi Electric Corporation, Tokyo (JP)

(21) Appl. No.: 11/527,526

(22) Filed: Sep. 27, 2006

(30) Foreign Application Priority Data
Apr. 5, 2006 (JP) 2006-104277

(51) Int. Cl. A47J 36/02

(52) U.S. Cl. 228/101

(57) ABSTRACT

A solder alloy is provided in which generation of an oxide film of Zn—Sn based or Zn—In based solder alloy, which can be easily oxidized, can be restrained without deteriorating the mechanical characteristics, and a soldering method that causes less joining defects is provided. Soldering is performed in an inert atmosphere or reductive atmosphere, using a solder alloy containing one or more of Sn and In at a maximum of 50% by weight and containing P at 0.0005% by weight or more and less than 0.001% by weight, with the remaining part made of Zn and unavoidable impurities.

### BACKGROUND OF THE INVENTION

1. Field of the Invention

This invention relates to a solder alloy used for mounting parts onto a wiring board that constitutes an electronic device or the like, or for joining a semiconductor device and a base member, and a soldering method using the solder alloy.

2. Description of the Related Art

As the problem of toxicity of Pb has arisen in terms of groundwater contamination or the like and the movement to limit the use of Pb in electric and electronic products has been reinforced worldwide, Sn—Pb based solder that has been broadly used for mounting parts onto wiring boards of electronic devices are now being replaced by Sn-group non-Pb-containing alloys such as Sn—Ag based and Sn—Zn based solder. Sn—Pb based alloy, which has been conventionally used most frequently, is an alloy having a composition ratio of approximately 63% by weight of Sn and 37% by weight of Pb that realizes the lowest melting point in this alloy series. Its melting point is approximately 183° C. As for the solder alloys that are generally used as non-Pb-containing solder, Sn—Ag based alloy has a melting point of approximately 220° C. and Sn—Zn based alloy have a melting point of approximately 200° C., both of which are higher than the melting point of the conventional Pb-containing solder.

Meanwhile, connection within an electronic part must be carried out with a solder alloy having a higher melting point than the solder alloy for mounting onto a board, so that the solder connection part inside the electronic part will not melt when mounting the electronic part onto an electronic circuit board. When mounting the electronic part onto the electronic circuit board, it is heated to approximately 250° C. Therefore, the solder alloy used for internal connection of the electronic part must have a melting point higher than 250° C. For the Sn—Pb based alloy, its melting point can be changed relatively largely by adjusting the content ratio of Sn and Pb. As the content ratio of Pb is increased, a higher melting point can be achieved. For example, in the case of an Sn—Pb alloy containing Sn at 5% by weight and Pb at 95% by weight, its melting point exceeds 300° C. The Sn—Pb alloy containing Sn at 5% by weight and Pb at 95% by weight, for example, has been used for internal connection of conventional electronic parts. However, to prevent environmental pollution by Pb, the use of non-Pb-containing alloys for internal connection of electronic parts is socially demanded.

Candidates for non-Pb-containing alloys having a melting point of approximately 300° C., higher than 250° C. like the Sn—Pb alloy containing Sn at 5% by weight and Pb at 95% by weight, may be Au—Sn based, Zn—Sn—Al—Mg based, Sn—Sb based, Bi—Sn based, Bi—Ag based alloys and the like. However, all of these have harder and more fragile mechanical characteristics than the conventional Sn—Pb based alloy. Moreover, the Au—Sn based alloy is very expensive and Sb contained in the Sn—Sb based alloy is highly toxic, which is a problem.

On the other hand, a Zn—Sn based alloy can be considered for an alloy having relatively flexible mechanical characteristics and having a liquidus temperature of 300° C. or higher. However, since Zn can be easily oxidized and the oxidized Zn oxide film cannot be easily broken, it may be a disruptive element against solderability. To solve this problem, an alloy produced by adding P at 0.001 to 1% by weight to a Zn—Sn based alloy has been proposed, as disclosed in JP-A-2005-52869.

As P is added at 0.001 to 1% by weight to the conventional Zn—Sn based solder alloy, P is preferentially oxidized and the P oxide film covers the surface, thus enabling restraint of oxidation of Zn and Sn and enabling improved solderability. However, P forms an intermetallic compound together with Sn and crystallizes as a sharp-shaped crystal. Therefore, there is a problem that, if the quantity of the Sn—P intermetallic compound increases, the mechanical characteristics of the solder alloy, particularly the elongation at break, is deteriorated.

Moreover, even if the generation of a Zn and Sn oxide film can be restrained by adding P at 0.001 to 1% by weight to the Zn—Sn based alloy, when a flux is used for soldering with this alloy, the reaction with this flux causes generation of a large quantity of hydrogen gas and the hydrogen has is taken into the melted solder alloy to form voids therein. This often causes soldering defects.

### SUMMARY OF THE INVENTION

In view of the foregoing status of the art, it is an object of this invention to provide a solder alloy in which generation of an oxide film can be restrained without deteriorating the mechanical characteristics, and a soldering method that enables formation of a junction part having no joining defects such as voids.

A solder alloy according to one aspect of this invention contains one or more of Sn and In at a maximum of 50% by weight, and contains P at 0.0005% by weight or more and less than 0.001% by weight, with the remaining part made of Zn and unavoidable impurities.

A solder alloy according to another aspect of this invention contains one or more of Sn and In at a maximum of 50% by weight, and contains Al or Mg at 0.05% or more and 0.5% or less, with the remaining part made of Zn and unavoidable impurities.

A soldering method according to another aspect of this invention includes performing soldering in an inert atmosphere or reductive atmosphere, using a solder alloy containing one or more of Sn and In at a maximum of 50% by weight and containing P at 0.0005% by weight or more and less than 0.001% by weight, with the remaining part made of Zn and unavoidable impurities.

A soldering method according to still another aspect of this invention includes performing soldering in an inert atmosphere or reductive atmosphere, using a solder alloy containing one or more of Sn and In at a maximum of 50% by weight and containing Al or Mg at 0.05% or more and 0.5% or less, with the remaining part made of Zn and unavoidable impurities.

This invention has an effect that a high-temperature solder alloy can be provided in which generation of an oxide film can be restrained without deteriorating the mechanical characteristics.

This invention also has an effect that a soldering method can be provided that enables formation of a soldered junction part having no joining defects such as voids.

### BRIEF DESCRIPTION OF THE DRAWINGS

FIG. 1 is a correlation chart showing the characteristics of a solder alloy according to Embodiment 1 of this invention.

FIG. 2 is a correlation chart showing the characteristics of a solder alloy according to Embodiment 2 of this invention.

FIG. 3 is a schematic view showing a cross section of a soldered junction part according to Embodiment 3 of this invention.

FIG. 4 is a schematic view showing a cross section of a soldered junction part formed by a conventional soldering method in Embodiment 3 of this invention.

FIG. 5 is a structural view showing a method of supplying melted solder alloy according to Embodiment 4 of this invention.

FIG. 6 is a structural view showing a method of supplying melted solder alloy according to Embodiment 5 of this invention.

### DETAILED DESCRIPTION OF THE PREFERRED EMBODIMENTS

### Embodiment 1

In Embodiment 1 of this invention, a solder alloy containing one or more of Sn and In at a maximum of 50% by weight and containing P at 0.0005% by weight or more and 0.005% by weight or less, with the remaining part made of Zn and unavoidable impurities, is provided. With this solder alloy, a high-temperature solder alloy can be provided in which generation of an oxide film can be restrained without deteriorating the mechanical characteristics.

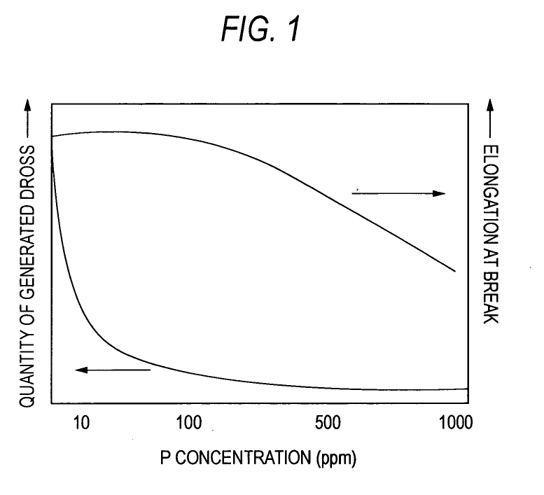

FIG. 1 is a correlation chart showing the relation between P concentration in the solder alloy according to Embodiment 1 and its elongation at break in a static tensile test, and the relation between P concentration and the quantity of generated oxide that is generally called “dross” in a jet soldering device.

The basic composition of the solder alloy is, for example, Sn at 30% and the remaining part is made of Zn. At a P concentration higher than 0.0005%, the quantity of generated dross is dramatically reduced and the antioxidant effect of P is achieved. Meanwhile, at a P concentration higher than 0.05%, the elongation at break starts decreasing and the ductility of the material is lowered. Therefore, for the soldering material, it is appropriate that the P concentration is within a range of 0.0005% or more and 0.05% or less.

Here, the alloy containing Sn at 30% and P at 0.0005% or more and 0.05% or less, with the remaining part made of Zn, is described. However, with Zn—Sn based alloys having other composition ratios, the similar effect is achieved if the content ratio of Sn is 50% or less. Also, with Zn—In based alloys, the similar effect is achieved if the content ratio of In is 50% or less.

### Embodiment 2

In Embodiment 2 of this invention, a solder alloy containing one or more of Sn and In at a maximum of 50% by weight and containing Al or Mg at 0.05% or more and 0.5% or less, with the remaining part made of Zn and unavoidable impurities, is provided. As in Embodiment 1, a high-temperature solder alloy can be provided in which generation of an oxide film can be restrained without deteriorating the mechanical characteristics.

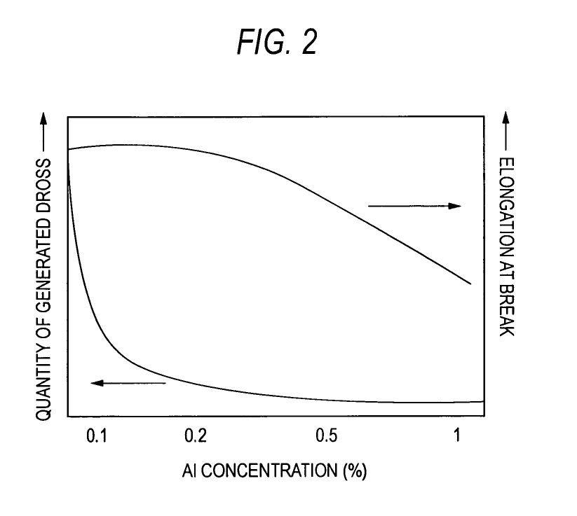

FIG. 2 is a correlation chart showing the relation between Al concentration in the solder alloy according to Embodiment 2 and its elongation at break in a static tensile test, and the relation between Al concentration and the quantity of generated oxide that is generally called “dross” in a jet soldering device.

The basic composition of the solder alloy is, for example, Sn at 30% and the remaining part is made of Zn. At an Al concentration higher than 0.05%, the quantity of generated dross is dramatically reduced and the antioxidant effect of Al is achieved. Meanwhile, at an Al concentration higher than 0.5%, the elongation at break starts decreasing and the ductility of the material is lowered. Therefore, for the soldering material, it is appropriate that the Al concentration is within a range of 0.05% or more and 0.5% or less.

Here, the alloy containing Sn at 30% and Al at 0.05% or more and 0.5% or less, with the remaining part made of Zn, is described. However, with Zn—Sn based alloys having other composition ratios, the similar effect is achieved if the content ratio of Sn is 50% or less. Also, with Zn—In based alloys, the similar effect is achieved if the content ratio of In is 50% or less.

Moreover, when Mg is added instead of Al, the correlation between Mg concentration and the dross reducing effect is similar to that in the case of adding Al, and also the influence on the static mechanical characteristics such as elongation at break is similar to that in the case of adding Al.

### Embodiment 3

In Embodiment 3, a soldering method is provided in which soldering is performed in an inert atmosphere or reductive atmosphere, using a solder alloy containing one or more of Sn and In at a maximum of 50% by weight and containing P at 0.0005% by weight or more and less than 0.05% by weight, with the remaining part made of In and unavoidable impurities. A soldering method that enables formation of a soldered junction part having no joining defects such as voids is provided.

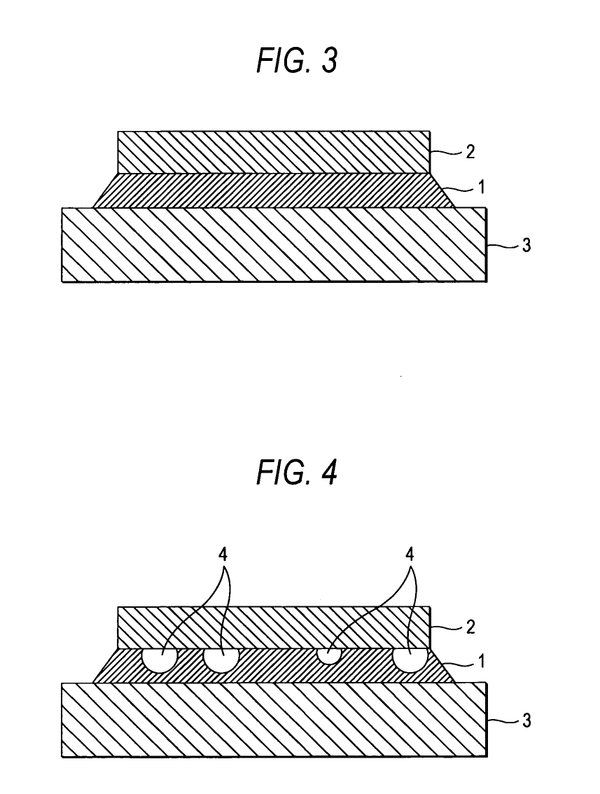

FIG. 3 is a schematic view showing a cross section of a junction part made of a Zn—Sn—P based solder alloy according to Embodiment 3 of this invention.

In FIG. 3, 1 represents a soldering material used for junction, for example, Zn-30Sn-0.0005P (where the numerical values representing the percentage of each and the remaining part is Zn). 2 represents a joined member, for example, an Si chip having its surface metallized with Ni. 3 represents a base member, for example, a Cu plate having its surface Ni-plated. This junction part is formed as follows. That is, the Zn—Sn—P solder alloy 1, which is processed into a plate shape, is first superimposed onto the Cu plate 3 in an atmospheric gas containing oxygen at a concentration of 100 ppm and hydrogen at a concentration of 3%, with the remaining part being nitrogen. Then, after the Si chip 2 is superimposed thereon, they are heated to the melting point of the Zn—Sn—P alloy 1 or higher, for example, 400° C., and then cooled. Thus, sufficient wetting is provided between the joined member and the solder material, and a good junction part having no joining defects such as voids is formed.

Meanwhile, FIG. 4 is a schematic view showing a cross section of a junction part in the case where the same solder alloy, Si chip and Cu plate are used and heated in the atmosphere using a flux.

In FIG. 4, 1 to 3 represent the same members as in Embodiment 3 of this invention and 4 represents voids generated in the solder. In this manner, in the case where a flux is used in the atmosphere, gas generated by the reaction between the flux and the oxide film on the surface of the solder material is caught in the melted solder. Therefore, it is extremely difficult to prevent generation of voids.

As described above, as soldering is performed by heating, for example, in an atmospheric gas containing oxygen gas at a concentration of 100 ppm and hydrogen at a concentration of 3%, with the remaining part being nitrogen, a junction part having no joining defects such as voids can be provided.

In this embodiment, the case of using Zn-30Sn-0.0005P as the solder alloy is described. However, with Zn—Sn based alloys having other composition ratios, the similar effect is achieved if the content ratio of Sn is 50% or less and the P concentration is within the range of 0.0005% or more and 0.05% or less. Also, with Zn—In based alloys, the similar effect is achieved if the content ratio of In is 50% or less and the P concentration is within the range of 0.0005% or more and 0.05% or less. Also in the case of adding Al or Mg instead of P to the solder alloy, the same effect is achieved if the rate of addition is 0.5% or less. Moreover, though the case of using the atmospheric gas containing oxygen at a concentration of 100 ppm and hydrogen at a concentration of 3% with the remaining part being nitrogen, as the reductive atmosphere, is described in this embodiment, the oxygen concentration is not limited to this if it is sufficiently low, and the atmospheric gas need not contain hydrogen if the oxide film on the surface of the joined member has less influence. The inert gas is not limited to nitrogen, and there is no problem in using argon or the like if it is not oxidative. The junction property is better as the oxygen concentration is lower. However, a sufficient void restraining effect is provided if it is 1000 ppm or less.

### Embodiment 4

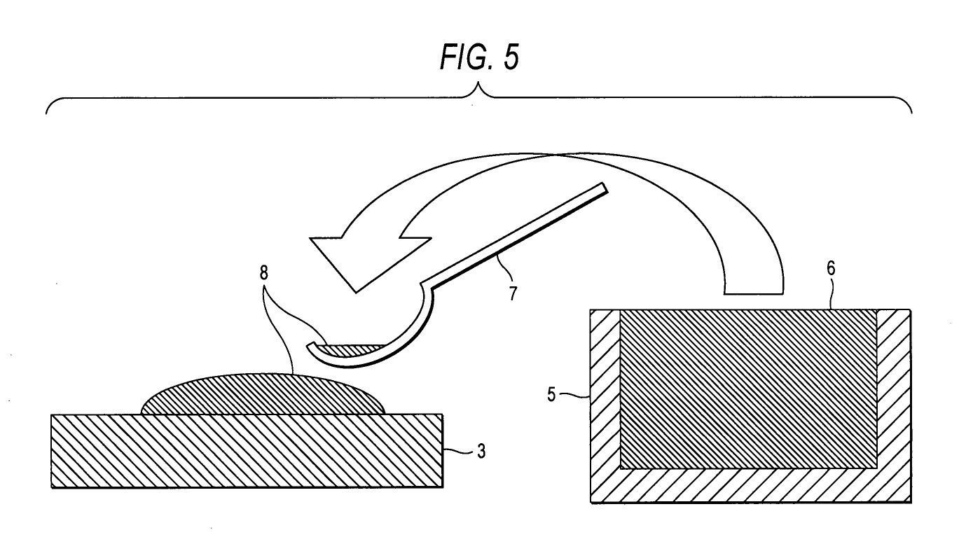

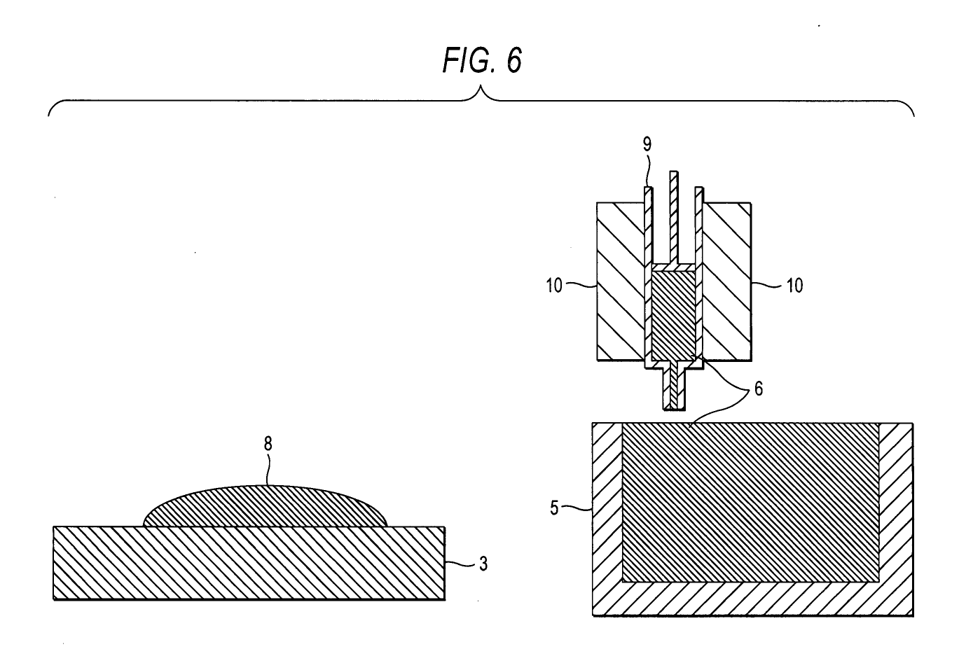

FIG. 5 is a structural view showing a soldering method according to Embodiment 4 of this invention. In FIG. 5, 5 represents a crucible placed in, for example, an inert or reductive atmosphere. 6 represents a solder alloy, for example, Zn-30Sn-0.0005P, heated and melted in the crucible. 7 represents an appliance for scooping the melted solder 6 from the crucible 5 and supplying the melted solder 6 onto the base member 3, for example, a spoon made of stainless steel that has been surface-treated so as not to easily react with the solder. 8 represents the solder supplied onto the base member 3 by the spoon 7.

A Zn—Sn based alloy can be oxidized very easily in the atmosphere. Therefore, even in the case where a plate member having an extremely clean surface is produced, if it is stored without being treated in the atmosphere, an oxide film that is mainly Zn oxide covers the surface of the solder material within a very short time. The oxide film, once formed, remains on the surface even when the solder material is melted. This oxide film cannot be easily broken unless an external force such as rocking or shaking is applied thereto. This oxide film disrupts the soldering, causing voids and wetting failure.

On the other hand, in the method described in Embodiment 4, since the solder alloy 6 is melted in the crucible 5 in an inert atmosphere or reductive atmosphere, further oxidation of the solder material can be restrained only if the oxide film floating on the surface of the solder alloy 6 is removed. Thus, by scooping and supplying the solder alloy that is not oxidized, with the spoon 7, it is possible to perform soldering with the solder containing no oxide film.

In this Embodiment 4, the case of using Zn-30Sn-0.0005P as the solder alloy is described. However, the solder alloy is not limited to this, as in Embodiment 3. The similar effect is achieved by other means than the spoon as long as it can supply the melted solder to the joined part.

### Embodiment 5

FIG. 6 is a structural view showing a soldering method according to Embodiment 5 of this invention. In FIG. 6, 9 represents a liquid metal ejection device that is fed with liquid metal by lowering the pressure in its space below the external pressure and ejects the liquid metal by raising the pressure in the space. For example, it is a syringe formed by a glass cylinder and a glass piston. 10 represents a jig that has a heating mechanism such as a heater therein and holds the cylinder while heating it. The other parts of the construction are the same as in Embodiment 4.

In this Embodiment 5, since the syringe is used as an appliance for supplying the solder alloy 6 onto the base member 3, which is the joined part, a portion containing no oxide film can be easily sucked from the inside of the solder alloy 6 melted in the crucible 5. Thus, clean solder containing no oxide film can be supplied to the joined part repeatedly and continuously.

In this Embodiment 5, the case of using the glass syringe as the liquid metal ejection device 9 is described. However, the liquid metal ejection device is not limited to this and any appliance that can lower the pressure in the space where the liquid metal is held, below the external pressure, can be used. The similar effect is achieved with a diaphragm made of a heat-resistance material that can resist the temperature of the melted solder alloy.

The syringe is not limited to glass and it may be made of metal or ceramics. If oxide film or nitride film treatment does not react with the solder alloy is made on the surface of the syringe that contacts the melted solder, its durability improves.

Moreover, since the heating mechanism such as a heater is provided in the jig that holds the syringe, the melted solder alloy sucked in the syringe can be prevented from solidifying, and the syringe replacement work can be easily done. However, if the heating mechanism is provided in the syringe itself, the efficiency of heat transfer to the solder alloy improves and therefore it is possible to set the temperature of the heating mechanism at a low temperature.

Also, the heating mechanism may be constructed separately from the arrangement of the syringe and the like constituting the space where the solder alloy is held, and the arrangement constituting the space where the solder alloy is held may be heated by radiation or convection heat transfer.

In this embodiment, the case of using Zn-30Sn-0.0005P as the solder alloy is described. However, the solder alloy is not limited to this, as in Embodiments 3 and 4.

What is claimed is:

1. A solder alloy containing one or more of Sn and In at a maximum of 50% by weight, and containing P at 0.0005% by weight or more and 0.05% by weight or less, with the remaining part made of Zn and unavoidable impurities.

2. A solder alloy containing one or more of Sn and In at a maximum of 50% by weight, and containing Al or Mg at 0.05% or more and 0.5% or less, with the remaining part made of Zn and unavoidable impurities.

3. A soldering method comprising performing soldering in an inert atmosphere or reductive atmosphere, using a solder alloy containing one or more of Sn and In at a maximum of 50% by weight and containing P at 0.0005% by weight or more and 0.05% by weight or less, with the remaining part made of Zn and unavoidable impurities.

4. A soldering method comprising performing soldering in an inert atmosphere or reductive atmosphere, using a solder alloy containing one or more of Sn and In at a maximum of 50% by weight and containing Al or Mg at 0.05% or more and 0.5% or less, with the remaining part made of Zn and unavoidable impurities.

5. The soldering method as claimed in claim 3, wherein oxygen concentration in the inert atmosphere or reductive atmosphere is 1000 ppm or less.

6. The soldering method as claimed in claim 3, wherein the solder alloy, which is a joining member, is melted in advance and then supplied to a joined part.

7. The soldering method as claimed in claim 6, wherein the solder alloy is supplied by a liquid metal ejection device that is fed with liquid metal by lowering the pressure in a space where the liquid metal is held, below the external pressure, and that ejects the liquid metal by raising the pressure in the space.

8. The soldering method as claimed in claim 7, wherein the liquid metal ejection device changes the pressure in the space where the solder alloy is held, by a combination of a piston and cylinder, or by a diaphragm.

9. The soldering method as claimed in claim 7, wherein a surface of the liquid metal ejection device that contacts the solder alloy is made of material that does not chemically react with the solder alloy.

10. The soldering method as claimed in claim 7, wherein a surface of the liquid metal ejection device that contacts the solder alloy is made of a metal having an oxide film or nitride film, or ceramics or glass.

11. The soldering method as claimed in claim 7, wherein the liquid metal ejection device has a heating mechanism that maintains a temperature equal to or higher than the melting point of the solder alloy.

12. The soldering method as claimed in claim 11, wherein in the liquid metal ejection device, the heating mechanism is directly attached to an arrangement constituting the space where the solder alloy is held.

13. The soldering method as claimed in claim 11, wherein in the liquid metal ejection device, the heating mechanism is constructed separately from an arrangement constituting the space where the solder alloy is held, and the arrangement constituting the space where the solder alloy is held is heated by radiation or convection heat transfer.
